(19) United States
(12) Patent Application Publication
(10) Pub. No.: US 2014/0333944 A1
(43) Pub. Date: Nov. 13, 2014

(54) IMAGE FORMING APPARATUS

(71) Applicant: Sharp Kabushiki Kaisha, Osaka (JP)

(72) Inventor: Nobuyuki UEDA, Osaka (JP)

(73) Assignee: Sharp Kabushiki Kaisha, Osaka (JP)

(21) Appl. No.: 14/202,037

(22) Filed: Mar. 10, 2014

(30) Foreign Application Priority Data
May 13, 2013 (JP) 2013-100969

(51) Int. Cl. G06K 15/02

(52) U.S. Cl. CPC G06K 15/025
USPC 358/1.12

(57) ABSTRACT

An image forming apparatus is provided with a sample printing execution portion which, during execution of a print job, generates two printed matters for at least a part of pages of the print job on a same printing condition, discharges one of the printed matters to a first paper discharge tray as a printed matter of the print job, and discharges the other printed matter to a second paper discharge tray different from the first paper discharge tray as a sample printed matter. The sample printing execution portion, when performing sample printing of the sample printed matter, prints the printing condition of the print job corresponding to the sample printing, and discharges a sheet having the printing condition printed thereon to the second paper discharge tray.

This non-provisional application claims priority under 35 U.S.C. §119(a) on Patent Application No. 2013-100969 filed in JAPAN on May 13, 2013, the entire contents of which are hereby incorporated herein by reference.

### FIELD OF THE INVENTION

The present invention relates to an image forming apparatus, and more specifically to an image forming apparatus provided with a sample printing function for confirming a printed state of a printed matter during execution of a print job.

### BACKGROUND OF THE INVENTION

In recent years, an image forming apparatus such as an MFP (digital multi-functional peripheral) increasingly has a larger size, a higher function and a higher speed, and becomes possible to generate a large amount of printed matters in a short time. Printed matters printed by such an image forming apparatus are accommodated in a paper discharge tray of a large-capacity stacker from one to the next. Therefore, it is difficult to take out printed matters from the large-capacity stacker while the image forming apparatus is executing a print job. Accordingly, a user needs to visually confirm a printed state (image quality, a finished state) of printed matters after the print job ends, and, particularly, in the case of a large amount of printed matters, burden on the user is large.

Against this, for example, Japanese Laid-Open Patent Publication No. 2010-72022 discloses an image forming apparatus provided with a sample printing function which allows a user to confirm a printed state of printed matters even while the image forming apparatus is executing a print job. According to this, during execution of the print job, printed matters by the print job are discharged to a large-capacity stacker, while sample printing is executed at a sample printing interval which is set in advance, and the obtained sample printed matter is discharged to a tray for sample paper discharging which is different from the large-capacity stacker.

That is, this sample printing function is for allowing a user to judge whether or not printing quality of a printed matter achieves a certain standard visually or the like even during execution of a print job. For example, in a case where the print job is composed of a plurality of pages, paper feeding and printing are repeated twice with respect to a page specified by an operation of the user and two printed matters are generated with the same printing condition. Then, one of the printed matters is discharged to a paper discharge tray of the large-capacity stacker and the other printed matter is discharged to a different paper discharge tray for sample paper discharging as a sample printed matter. This makes it possible for the user to confirm the sample printed matter which is discharged to the tray for sample paper discharging visually. That is, since this sample printed matter and printed matters which are discharged to the large-capacity stacker from one to the next are printed with the same printing condition, by confirming the sample printed matter, the user is able to judge a printed state of the original printed matters.

However, in the technology described in Japanese Laid-Open Patent Publication No. 2010-72022 described above, the user is not able to know the printing condition (for example, printed date and time, what copy number it is, a paper feed tray and the like) of the print job corresponding to sample printing. Thus, there is a problem that the user is not able to grasp when the sample printed matter is printed, what copy number the sample printed matter is in the case of the print job with a plurality of copies, in which paper feed tray the sample printed matter is, or the like. Therefore, in a case where waste (loss) paper due to printing is generated, it is difficult to specify date and time when the waste paper is generated, a copy number (position) that the waste paper is generated, cause of generating the waste paper, and the like.

### SUMMARY OF THE INVENTION

The present invention aims to provide an image forming apparatus capable of performing confirming of a printed state (image quality) of a printed matter and confirming of a printing condition at the same time when sample printing is performed during execution of a print job.

An object of the present invention is to provide an image forming apparatus provided with a sample printing execution portion which, during execution of a print job, generates two printed matters for at least a part of pages of the print job on a same printing condition, discharges one of the printed matters to a first paper discharge tray as a printed matter of the print job and discharges the other printed matter to a second paper discharge tray different from the first paper discharge tray as a sample printed matter, wherein the sample printing execution portion, when performing sample printing of the sample printed matter, prints the printing condition of the print job corresponding to the sample printing, and discharges a sheet having the printing condition printed thereon to the second paper discharge tray.

Another object of the present invention is to provide the image forming apparatus, wherein the sheet having the printing condition printed thereon is a sheet before or after the sample printed matter.

Another object of the present invention is to provide the image forming apparatus, wherein the sheet having the printing condition printed thereon is a sheet of the sample printed matter, and the printing condition is printed in a margin part of the sample printed matter.

Another object of the present invention is to provide the image forming apparatus, wherein the printing condition includes an execution condition showing whether sample printing of the sample printed matter is executed automatically or executed manually.

Another object of the present invention is to provide the image forming apparatus, wherein the printing condition includes printed date and time when the sample printed matter is subjected to sample printing, a copy number showing, when the print job is a print job of a plurality of copies, to what copy number the sample printed matter corresponds.

Another object of the present invention is to provide the image forming apparatus, wherein a laser scanning portion for emitting laser light corresponding to image data of the print job to a photoreceptor drum, a high voltage generating portion for applying predetermined high voltage to a charging device, a developing device, and a transfer device arranged around the photoreceptor drum are included, and the printing condition includes a paper feed tray when the sample printed matter is subjected to sample printing, a laser power setting value of the laser scanning unit when the sample printed matter is subjected to sample printing, and a high-voltage output setting value of the high voltage generating portion when the sample printed matter is subjected to sample printing.

Another object of the present invention is to provide the image forming apparatus, wherein a measuring portion for measuring temperature and humidity in the image forming apparatus is included, and the printing condition further includes temperature and humidity in the image forming apparatus by the measuring portion when the sample printed matter is subjected to sample printing.

### BRIEF DESCRIPTION OF THE DRAWINGS

FIG. 1 is a sectional view showing an example of a main configuration of an image forming apparatus according to an embodiment of the present invention;

FIG. 2 is a schematic block diagram showing a configuration example of the image forming apparatus of FIG. 1;

FIG. 3 is an external view showing an example of a touch panel and a key operation portion of the image forming apparatus of FIG. 2;

FIG. 4A and FIG. 4B are views showing an example of print output of a printing condition of a print job corresponding to a sample printed matter;

FIG. 5A and FIG. 5B are views showing an example of a standard screen and a sample printing setting screen of the image forming apparatus;

FIG. 6 is a view showing an example of a screen during execution of a print job; and

FIG. 7 is a flowchart explaining an example of sample printing processing by the image forming apparatus of the present invention.

### PREFERRED EMBODIMENTS OF THE INVENTION

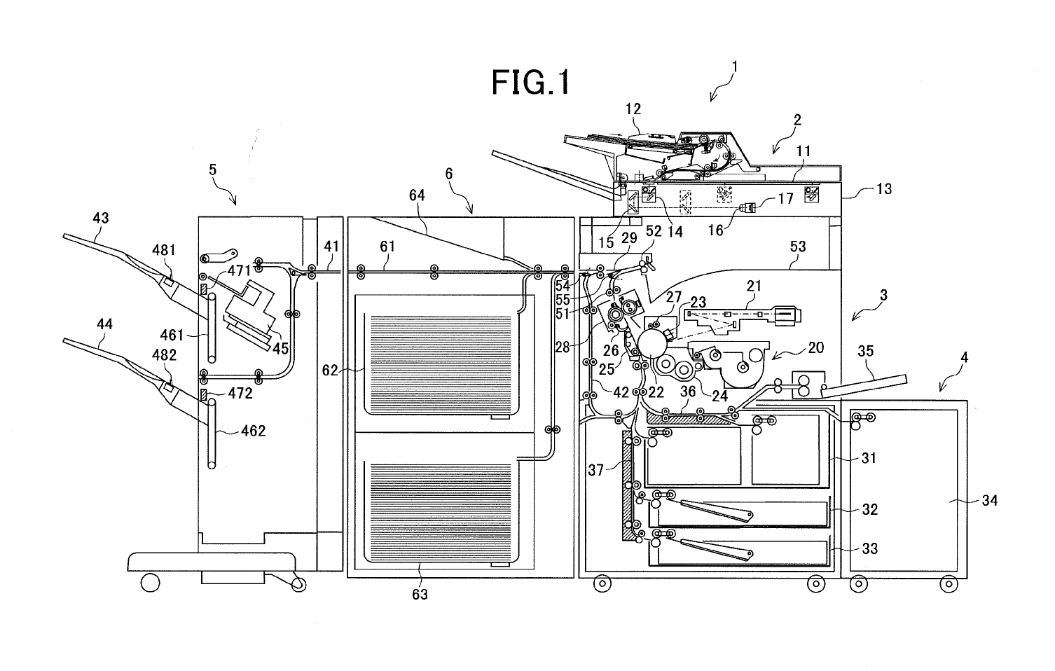

FIG. 1 is a sectional view showing an example of a main configuration of an image forming apparatus according to an embodiment of the present invention, in which 1 denotes the image forming apparatus. The image forming apparatus 1 is able to be exemplified as a digital multi-functional peripheral (MFP), and is mainly composed of an image reading portion 2, an image forming portion 3, a paper feeding portion 4, a post-processing device 5, and a large-capacity stacker 6.

As shown in FIG. 1, the image reading portion 2 is composed of a document platen 11 made of transparent glass, a reversing automatic document feeder (RADF) 12 for automatically supplying a document to the document platen 11, and a document image reading unit for scanning and reading an image of the document placed on the document platen 11, that is, a scanner unit 13.

The RADF 12 is a well-known device for setting a plurality of sheets of documents on a predetermined document tray at one time to automatically feed the set documents sheet by sheet onto the document platen 11 of the scanner unit 13. Then, the RADF 12 is composed of a conveying path for a single-sided document, a conveying path for a double-sided document, conveying path switching means for switching these conveying paths and the like, so as to cause the scanner unit 13 to read a single side or double sides of a document according to selection of a user.

The scanner unit 13 is composed of a first scan unit 14 equipped with a lamp reflector assembly for exposing a document surface to light and a first reflective mirror for guiding to a photoelectric conversion element (CCD) 17 that converts a reflected light image from the document into an electric image signal, a second scan unit 15 equipped with second and third reflective mirrors, and an optical lens body 16 for forming the reflected light image on the CCD 17. The first scan unit 14 runs at a constant speed V from left to right along the document platen 11, and the second scan unit 15 is subjected to scanning control so as to run at a V/2 speed in the same direction.

Thereby, at the image reading portion 2, a document image is read by, while sequentially placing a document to be read on the document platen 11 with actions of the RADF 12 correlated to the scanner unit 13, moving the scanner unit 13 along a lower face of the document platen 11 to sequentially form an image of the document placed on the document platen 11 by the CCD 17 for each one line. Image data obtained by reading the document image with the scanner unit 13 is once stored in a memory (not-shown) after various processing is applied, and the image data is output from the memory to the image forming portion 3 in response to output indication to be reproduced on a photoreceptor drum 22 as a visible image, thereafter the image is transferred onto a sheet to form a toner image.

This image forming portion 3 is provided with a laser scanning unit (LSU) 21 and an electrophotographic process portion 20 for forming an image. The laser scanning unit 21 has a semiconductor laser which emits laser light corresponding to image data which is read from a memory or image data which is transferred from an external device such as a personal computer, a polygon mirror which deflects laser light at an equiangular speed, an f-θ lens which performs correction so that the laser light deflected at the equiangular speed scans at a uniform speed on the photoreceptor drum 22 of the electrophotographic process portion 20, and the like.

The electrophotographic process portion 20 is configured so that, according to a publicly known aspect, a charging device 23, a developing device 24, a transfer device 25, a peeling device 26, a cleaning device 27 and a charge erasing device are arranged around the photoreceptor drum 22, and further a fixing device 28 is arranged on a downstream side of the photoreceptor drum 22.

The paper feeding portion 4 has first to third cassettes 31 to 33 and a manual tray 35. The first cassette 31 is a tandem tray which contains a first tray and a second tray, and both trays are able to be drawn from the apparatus main body at the same time. The second cassette 32 and the third cassette 33 contain a third tray and a fourth tray, respectively. That is, four trays are contained in three cassettes (31 to 33). Paper feeding and conveying portions 36 and 37 are provided with a paper feeding roller, a conveying roller and a registration roller in order to convey a sheet from the paper feeding portion 4 to a transfer position between the photoreceptor drum 22 and the transfer device 25.

In four trays in the first to third cassettes 31 to 33 in the paper feeding portion 4, sheets are layered for each size to be contained, and when a user selects a cassette or a tray containing desired sized sheets, the sheets are fed sheet by sheet from the top of a bundle of sheets in the tray, and sequentially conveyed toward the electrophotographic process portion 20 through conveying paths of the paper feeding and conveying portions 36 and 37.

A paper discharging path 29 is provided on a downstream side in a paper conveyance direction of the fixing device 28, and the paper discharging path 29 is branched into a paper discharging and conveying path 41 of the post-processing device and a paper re-feeding and conveying portion 42 for double-sided copying via the large-capacity stacker 6.

The image data read from a memory in the laser scanning unit 21 and the electrophotographic process portion 20 is scanned by the laser scanning unit 21 with laser beam, thereby forming on the surface of the photoreceptor drum 22 as an electrostatic latent image, and a toner image visualized by a toner of the developing device 24 is electrostatically transferred by the transfer device 25 onto the surface of a sheet conveyed from the paper feeding portion 4 to be fixed by the fixing device 28.

A sheet having the image formed thereon in this manner is sent from the fixing device 28 to the post-processing device 5 via the large-capacity stacker 6, or selectively conveyed to the paper re-feeding and conveying portion 42 for double-sided copying. The sheet sent to the post-processing device 5 is subjected to predetermined processing such as sort or staple processing as necessary, and stacked on a first discharge tray 43 or a second discharge tray 44. Moreover, the sheet sent to the paper re-feeding and conveying portion 42 for double-sided copying is reversed here to be conveyed to the electrophotographic process portion 20 again, and an image is formed on a back side of the sheet to be discharged after fixation.

The image forming apparatus 1 shown in FIG. 1 is provided with first to third cassettes 31 to 33 and the manual tray 35 in the apparatus main body, and further, as an option, a large-capacity cassette 34 is added as a fifth tray. An upwardly biased elevator is included inside the large-capacity cassette 34, sheets are accumulated in this elevator, a top sheet is in contact with the paper feeding roller, and the sheet is isolated and sent out by rotating the paper feeding roller and enters into the paper feeding and conveying portion 36 of the apparatus main body. The large-capacity cassette 34 is a large-capacity tray, and therefore, is able to contain standard sheets of the most frequently used size, for example, A4 size.

The post-processing device 5 is disposed on a left side of an image forming system, and is provided with the first discharge tray 43 and the second discharge tray 44. The second discharge tray 44 is a discharging portion that receives sheets having images formed thereon discharged from the image forming portion 3 by a received/discharged paper conveying path 41 provided at an upper part of a side face of the post-processing device 5 to discharge the sheets as they are. The first discharge tray 43 is a discharging portion that discharges sheets subjected to post-processing by post-processing means 45 which is mounted selectively such as stapling and punching. It is configured such that sheets having images formed thereon in the post-processing device 5 are discharged from the first discharge tray 43 or the second discharge tray 44 selected by a user.

The image forming apparatus 1 corresponds to double-sided printing, and the configuration therefor will be described below.

A sheet having an image recorded thereon is conveyed further upwardly by a conveying roller 51 through the fixing device 28 and passes through a switch gate 55. In a case where the discharge tray of the sheet is set to a stack tray 53 provided outside the image forming portion 3, the sheet is then discharged to the stack tray 53 by a reverse roller 52. On the other hand, in a case where double-sided image formation or post-processing is specified, the sheet is once discharged toward the stack tray 53 by a reverse roller 52. Note that, in this case, the sheet is not completely discharged and the reverse roller 52 is reversed while the sheet is kept nipped. Then, the above-described sheet is reversed and conveyed in an opposite direction, that is, a direction in which the paper re-feeding and conveying path 42 or the post-processing device 5 that is selectively mounted for double-sided image formation or post-processing is mounted.

At this time, the switch gate 55 is switched from a state of the solid line (upward) to a state of the broken line (downward) in the figure. In a case where double-sided image formation is performed, while a different switch gate 54 is in the upward (broken line) state, the sheet which is reversed and conveyed passes through the paper re-feeding and conveying portion 42, and is supplied to the image forming portion 3 again. On the other hand, in a case where post-processing is applied, while the different switch gate 54 is in the downward (solid line) state, the sheet is conveyed from the paper re-feeding and conveying portion 42 to the post-processing device 5 through the large-capacity stacker 6, followed by applying post-processing.

In the large-capacity stacker 6, as paper discharge trays for discharging sheets subjected to image formation (printed matters), an upper stacker tray 62, a lower stacker tray 63 and a tray for sample paper discharging 64 in the top are provided so as to be capable of paper discharging selectively. Moreover, without discharging into the large-capacity stacker 6, sheets are also able to be discharged thorough a through pass conveying path 61 to the further downstream post-processing device 5. The upper stacker tray 62 and the lower stacker tray 63 have a not-shown door which is openable and closable on a front face of the stackers, and when this door is opened, a whole basket to which printed matters are discharged is able to be taken out.

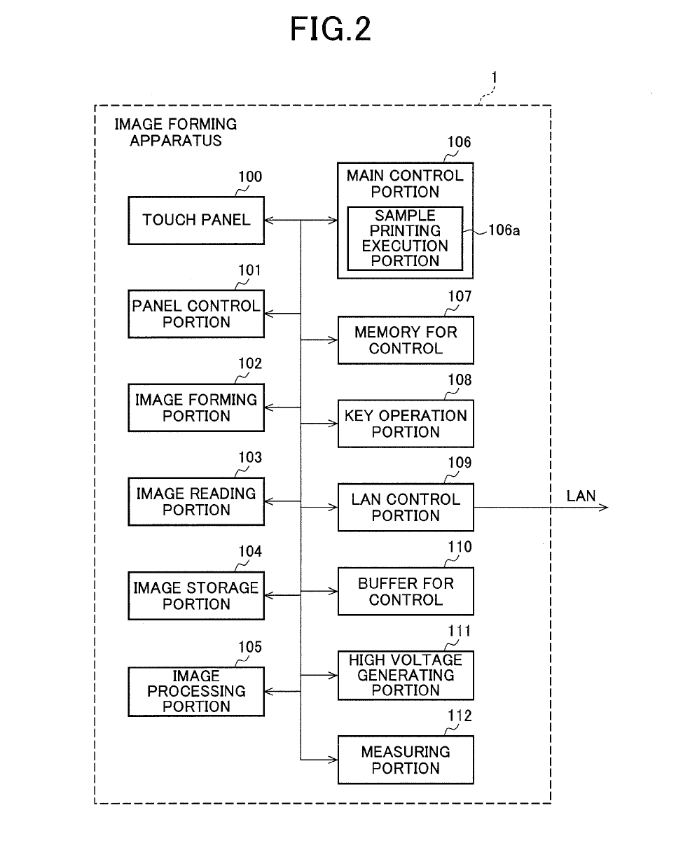

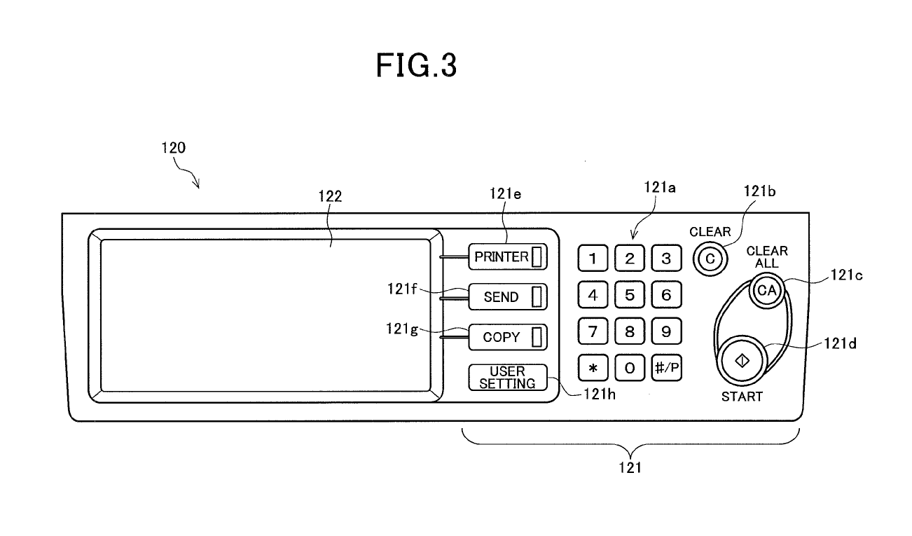

FIG. 2 is a schematic block diagram showing a configuration example of the image forming apparatus 1 of FIG. 1. FIG. 3 is an external view showing an example of a touch panel and a key operation portion of the image forming apparatus 1 of FIG. 2. The image forming apparatus 1 exemplified in FIG. 2 is provided with a touch panel 100, a panel control portion 101, an image forming portion 102, an image reading portion 103, an image storage portion 104, an image processing portion 105, a main control portion 106, a memory for control 107, a key operation portion 108, a LAN (Local Area Network) control portion 109, a buffer for control 110, a high voltage generating portion 111, and a measuring portion 112.

The main control portion 106 is composed of a CPU (Central Processing Unit) or a DSP (Digital Signal Processor), and the like. The memory for control 107 is composed of a non-volatile memory such as a ROM (Read Only Memory) or an EEPROM (Electrically Erasable and Programmable ROM), and the like. In the memory for control 107, a program (firmware) and various setting data are stored so as to be readable from the main control portion 106. Among them, at least various setting data is stored in a rewritable memory. Moreover, such a program and various setting data may be stored in the image storage portion 104. Further, the buffer for control 110 is composed of a volatile memory such as a RAM (Random Access Memory).

The above-described program is for giving instructions, including an instruction concerning a sample printing function according to the present invention, such as an instruction concerning generation, transmission, reception and the like of a facsimile image, an electronic mail and the like, an instruction concerning reading of a document, an instruction concerning printing, and an instruction concerning reading and printing (that is, copying) of a document, by the main control portion 106 for other parts. This program is developed on the buffer for control 110 by the main control portion 106, and is executed with the buffer for control 110 as a data area for temporal saving (working). Note that, a sample printing execution portion 106a according to the present invention is able to be realized as a function of the main control portion 106, more specifically, as a form of the above-described program.

The image reading portion 103 is a scanner using a CCD (Charge Coupled Device), and reads a document as a bitmap image of RGB (R: red, G: green, B: blue) with predetermined resolution to output the read RGB image data (dot image data) to the image processing portion 105. The image processing portion 105 is composed of an ASIC (Application Specific Integrated Circuit) and the like, and applies various image processing to target image data.

The image storage portion 104 is composed of a hard disk and the like, and stores such as image data read by the image reading portion 103 and passed through the image processing portion 105 and image data received from outside via the LAN control portion 109 or the like. Moreover, in the image storage portion 104, temporal saving of intermediate data generated during image processing at the image processing portion 105 and the like may be performed.

The image forming portion 102 is provided with a printer device employing a printing system such as an electrophotographic system or an ink jet system, and functions as image forming means for printing image data stored in the image storage portion 104 and the like on recording paper. Moreover, the high voltage generating portion 111 applies predetermined high voltage to the charging device 23, the developing device 24, and the transfer device 25 arranged around the photoreceptor drum 22 of FIG. 1 according to control from the main control portion 106. The high voltage generating portion 111 is a device which converts low voltage of 12 to 24 V into high voltage of several hundreds to several thousands V, applies this high voltage to each of the above-described devices (each of the rollers), and forms high voltage discharge to enable printing of characters.

The LAN control portion 109 is connected to the LAN to perform communication of electronic mail data and communication of internet FAX through the internet. The internet FAX is to transmit/receive an electronic mail through a computer network such as the LAN using a LAN interface and the like. Moreover, the measuring portion 112 is a temperature/humidity sensor for measuring temperature and humidity in the image forming apparatus 1.

The touch panel 100 or the key operation portion 108 is an operation input portion for receiving an operation for selecting desired processing from processing for reading a document and processing for transmitting, printing and the like of image data, an operation for staring the processing, an operation for performing setting which is required in the case of executing each processing (selection operation or input operation) and the like.

The key operation portion 108 is provided with a key group needed for operations. The touch panel 100 has a display portion and an operation receiving portion such as a touch sensor. The touch panel 100 is subjected to control of the display and control of operation reception by the panel control portion 101. That is, the panel control portion 101 performs display control of the display portion and control of operation reception of the operation receiving portion in the touch panel 100.

On the display portion of the touch panel 100, a current action state, setting information and the like are displayed. This display is realized by the panel control portion 101 for performing control so as to display a GUI (Graphical User Interface) image. The GUI makes it possible to change positions of the display and operation reception according to a user operation. Each GUI and an image thereof may be stored in an internal memory of the panel control portion 101 or the memory for control 107 so as to be readable. Moreover, as the display portion, display devices of various display formats are able to be employed, such as a liquid crystal display and an organic EL (Electroluminescence) display.

The user operation received on the touch panel 100 is interpreted by the panel control portion 101 and transferred to the main control portion 106 as an operation signal. The user operation received by the key operation portion 108 is interpreted by the key operation portion 108 itself and transferred to the main control portion 106 as an operation signal. The main control portion 106 gives an instruction corresponding to the operation signal obtained in this manner to other parts to cause other parts to execute processing corresponding to the user operation. Note that, though description has been given citing the touch panel 100 in which the display device and the operation portion are integrated, only the display device may be simply provided instead of the touch panel 100, and in this case, only the key operation portion 108 receives a user operation.

The touch panel 100 and the key operation portion 108 are configured as an operation panel 120 as exemplified in FIG. 3. In this example, the operation panel 120 is composed of a key operation portion 121 (corresponding to the key operation portion 108) provided with various hardware keys, and a touch panel 122 (corresponding to the touch panel 100) which is composed of a liquid crystal display and a touch sensor. Description will be given below by applying the touch panel 122 and the key operation portion 121 instead of the touch panel 100 and the key operation portion 108 in the configuration of FIG. 1.

The key operation portion 121 is provided with, as hardware keys, in addition to a numerical keypad 121a for inputting a numerical value, a clear key 121b for clearing a setting value which is input, a clear all key 121c for all clearing various setting which is input and a start key (start button) 121d for receiving indication of copy start, sending start or the like, function switch keys 121e, 121f and 121g for switching a print function, a send function and a copy function as well as a system setting key 121h for receiving setting by a user.

A main objet of the present invention is to enable to perform confirming of a printed state (image quality) of a printed matter and confirming of a printing condition at the same time when sample printing is performed during execution of a print job. As the configuration therefor, the image forming apparatus 1 is provided with a sample printing execution portion 106a (FIG. 2) that, during execution of a print job, generates two printed matters with the same printing condition for at least a part of pages of the print job to discharge one of the printed matters to a first paper discharge tray as a printed matter of the print job and discharge the other printed matter to a second paper discharge tray different from the first paper discharge tray as a sample printed matter. In the case of performing sample printing of a sample printed matter, this sample printing execution portion 106a prints the printing condition of the print job corresponding to the sample printing and discharges a sheet on which the printing condition is printed to the second paper discharge tray.

In the description above, the sample printing execution portion 106a is realized as a function of the main control portion 106 as described above, and controls actions of each portion concerning a sample printing function including the image reading portion 103 and the image forming portion 102. Moreover, the first paper discharge tray corresponds to the upper stacker tray 62 or the lower stacker tray 63 of FIG. 1, and the second paper discharge tray corresponds to the tray for sample paper discharging 64 of FIG. 1.

Here, assumed is a case where a print job is, for example, a print job for printing (copying) 50 copies of a document with 30 pages and a 30th page of each copy is set to be subjected to sample printing. When a document is set at a predetermined reading position and the start key 121d (FIG. 3) is pressed, the image forming apparatus 1 starts an action of reading the document, and stores image data of the read document in the image storage portion 104 through the image processing portion 105. Then, image data for 30 pages stored in the image storage portion 104 is sequentially read and subjected to printing processing by the image forming portion 102, while the number of pages and the number of copies are counted in the main control portion 106 during printing processing and these count values are stored in the memory for control 107. At a time when the count value of the memory for control 107 reaches the 30th page of the first copy, execution of sample printing is indicated from the sample printing execution portion 106a to the image forming portion 102. In response thereto, in the image forming portion 102, image data of the 30th page is printed twice with the same printing condition and two printed matters of the image data of the 30th page are generated. Then, one of the printed matters is discharged to the upper stacker tray 62 as a printed matter of the print job and the other printed matter is discharged to the tray for sample paper discharging 64 as a sample printed matter. In the case of the present example, this series of the sample printing processing is executed in the same manner also for the second and subsequent copies.

With the above-described sample printed matter, the user is able to confirm a printed state (image quality) of the printed matter even during execution of the print job. However, the user could not know the printing condition of the print job corresponding to the sample printing.

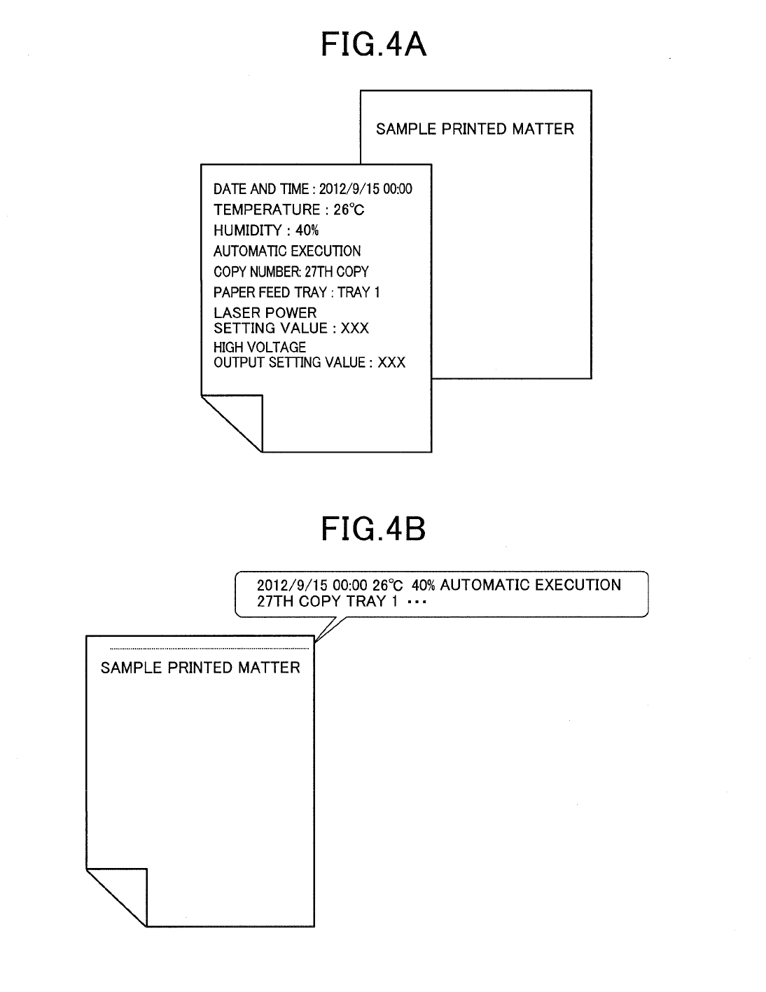

Against this, in the embodiment of the present invention, it is configured such that, in addition to a sample printed matter, the printing condition of a print job corresponding to sample printing (hereinafter, also referred to as the sample printing condition) is printed, and they are discharged to the same tray for sample paper discharging 64. Specifically, as shown in FIG. 4A and FIG. 4B, the sample printing condition is able to be printed on a sheet before or after the sample printed matter. Moreover, the sample printing condition may be printed in a margin part (for example, a header part, a footer part or the like) of the sample printed matter. FIG. 4A is an example of print output in a case where the sample printing condition is printed on a sheet before a sample printed matter, and FIG. 4B is an example of print output in a case where the sample printing condition is printed in a header part of a sample printed matter.

Moreover, the above-described sample printing condition is stored and managed in the main control portion 106 or the memory for control 107, and in the case of indicating execution of sample printing, the sample printing execution portion 106a obtains the sample printing condition from the main control portion 106 or the memory for control 107, and indicates the image forming portion 102 to print the obtained sample printing condition at a predetermined place. Note that, the predetermined place may be, as described above, a sheet before or after a sample printed matter, or a margin part such as a header part or a footer part of the sample printed matter.

In this manner, according to the present invention, when sample printing is performed during execution of a print job, in addition to a sample printed matter, the sample printing condition (for example, printed date and time, what copy number it is, a paper feed tray and the like) is printed, and they are discharged to the same paper discharge tray, thus making it possible to perform confirming of a printed state (image quality) of the printed matter and confirming of the printing condition at the same time. Therefore, in a case where waste (loss) paper due to printing is generated, the user is able to easily specify date and time or place when or where the waste paper is generated, cause of the waste paper and the like.

Note that, as shown in FIG. 4B, by printing the sample printing condition in a header part of a sample printed matter, it is not necessary to prepare a sheet for printing of the sample printing condition separately, thus making it possible to save sheets compared to the form of FIG. 4, therefore being more desirable.

Description will be given below specifically for the sample printing condition. It is preferable that the sample printing condition includes printed date and time when a sample printed matter is subjected to sample printing, a copy number showing, when a print job is a print job of a plurality of copies, to what copy number the sample printed matter corresponds, and an execution condition showing whether sample printing of the sample printed matter is executed automatically or executed manually. Note that, the printed date and time are able to be obtained by using a clock function (date and time) of the main control portion 106. Further, the copy number is counted by the main control portion 106 and is able to be obtained from the count value of the number of copies stored in the memory for control 107. Moreover, the execution condition of sample printing is able to be obtained from a setting value stored in the memory for control 107 based on a setting operation by the user.

In the description above, by printing printed date and time as the sample printing condition, the user is able to specify in what month and date and at what time the sample printed matter is printed. By collating executed date and time of a print job obtained from a print log or the like with printed date and time when sample printing is performed, the user is able to easily specify which sample printed matter is for which print job. Further, by printing a copy number as the sample condition, the user is bale to specify to what copy number of a print job a sample printed matter correspond. For example, in a case where a sample printed matter is specified to correspond to the print job of the 27th copy and image quality of this sample printed matter is deteriorated, the user is able to estimate that waste paper is generated in printed matters of 27th and subsequent copies.

Moreover, as described above, the image forming apparatus 1 is provided with the laser scanning unit 21 corresponding to a laser scanning portion which emits laser light according to image data of a print job to the photoreceptor drum 22, and the high voltage generating portion 111 which applies predetermined high voltage to the charging device 23, the developing device 24 and the transfer device 25 arranged around the photoreceptor drum 22. In addition, a paper feed tray when a sample printed matter is subjected to sample printing, a laser power setting value of the laser scanning unit 21 when the sample printed matter is subjected to sample printing, and high voltage output setting value of the high voltage generating portion 111 when the sample printed matter is subjected to sample printing may be further included as the sample printing condition. Note that, the above-described paper feed tray corresponds to any one of the first to third cassettes 31 to 33, the large-capacity cassette 34 and the manual tray 35 of FIG. 1. Such a paper feed tray, a laser power setting value and a high voltage output setting value may be stored in the memory for control 107. In this manner, by printing a paper feed tray, a laser power setting value and a high voltage output setting value which are internal factors of the image forming apparatus 1 as the sample printing condition, the user is able to confirm whether or not these settings are switched. That is, in a case where image quality of a sample printed matter is deteriorated, it is considered that these settings are more likely to be switched, thus making it possible to specify cause of generating waste paper promptly.

Moreover, as described above, the image forming apparatus 1 is provided with the measuring portion 112 for measuring temperature and humidity in the image forming apparatus 1. In addition, as the sample printing condition, temperature and humidity in the image forming apparatus 1 by the measuring portion 112 when a sample printed matter is subjected to sample printing may be further included. Temperature and humidity in the image forming apparatus 1 measured by the measuring portion 112 are also able to be stored in the memory for control 107. In this manner, by printing temperature and humidity which are external factors of the image forming apparatus 1 as the sample printing condition, the user is able to confirm whether or not temperature and humidity in the image forming apparatus 1 fall within an acceptable range. That is, in a case where image quality of a sample printed matter is deteriorated as well as temperature and humidity in the image forming apparatus 1 do not fall within the acceptable range, it is considered that the cause thereof is more likely to be such temperature and humidity, thus making it possible to specify cause of generating waste paper promptly.

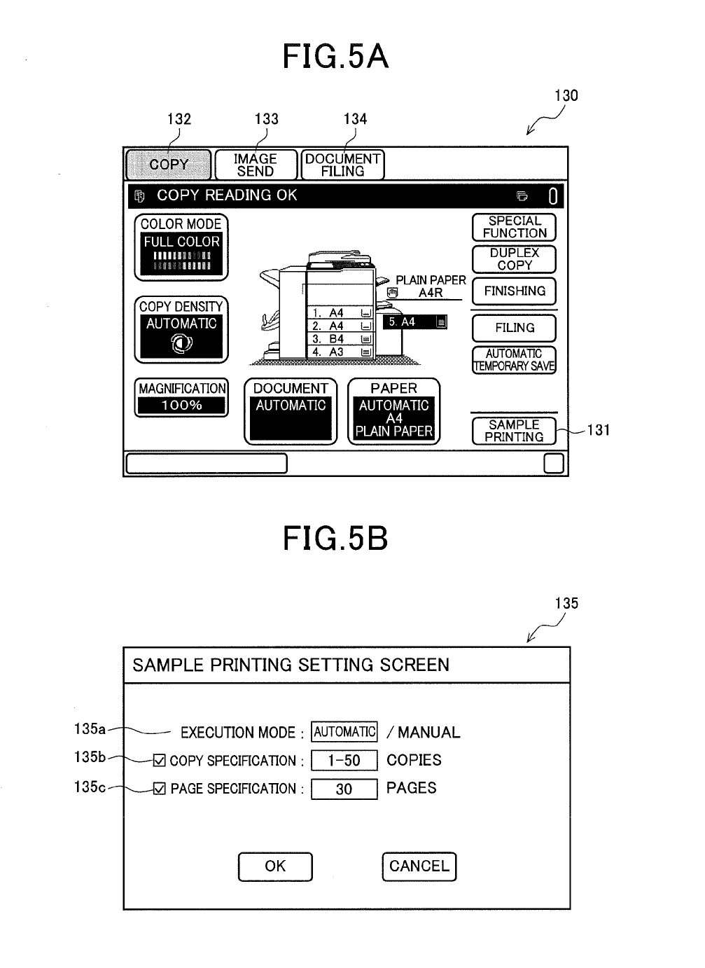

FIG. 5A and FIG. 5B are views showing an example of a standard screen and a sample printing setting screen of the image forming apparatus 1. A standard screen 130 shown in FIG. 5A is displayed on the touch panel 122 (FIG. 3) of the image forming apparatus 1 when power of the image forming apparatus 1 is turned on or reset. On this standard screen 130, a copy mode is selected by a copy tab 132 so that various condition setting for performing copy is enabled. In addition, a sample print key 131 is displayed on this standard screen 130, and the user is able to display the sample printing setting screen shown in FIG. 5B by operating the sample print key 131 using the touch panel 122. Note that, when an image send tab 133 is selected, the standard screen 130 moves to an image send mode to be switched to a screen for performing various condition setting for performing image sending, and when a document filing tab 134 is selected, moves to a document filing mode to be switched to a screen for performing various condition setting for performing document filing.

In FIG. 5B, a sample printing setting screen 135 has an execution mode selection field 135a capable of selecting either an automatic execution mode or a manual execution mode, and when the automatic execution mode is selected in the execution mode selection field 135a by an operation of the user, input to a copy specification input field 135b and a page specification input field 135c becomes effective. For example, in the case of a print job that 50 copies of a document with 30 pages/copy are printed, when, for example, “1-50” is input to the copy specification input field 135b and, for example, “30” is input to the page specification input field 135c, it is set so that the 30th page is automatically subjected to sample printing for each copy of 1 to 50 copies. Note that, specification of a copy and a page is not limited thereto, and a copy and a page which are desired to be targeted for sample printing are able to be specified as appropriate, and only either a copy or a page is also able to be specified.

Moreover, in FIG. 5B, in a case where the manual execution mode is selected in the execution mode selection field 135a by an operation of the user, input to the copy specification input field 135b and the page specification input field 135c becomes ineffective and the copy specification input field 135b and the page specification input field 135c are displayed in gray-out, for example. In this manner, when the user selects the execution mode of sample printing on the sample printing setting screen 135 and an “OK button” is pressed, setting contents are reflected, followed by returning to the standard screen 130 of FIG. 5A. Further, when a “cancel button” is pressed, setting contents remain not reflected, followed by returning to the standard screen 130 of FIG. 5A.

Here, in a case where the automatic execution mode is selected on the sample printing setting screen 135 of FIG. 5B, upon pressing of the start key 121d of FIG. 3, the image forming apparatus 1 starts a print job and executes sample printing automatically in accordance with setting contents on the sample printing setting screen 135.

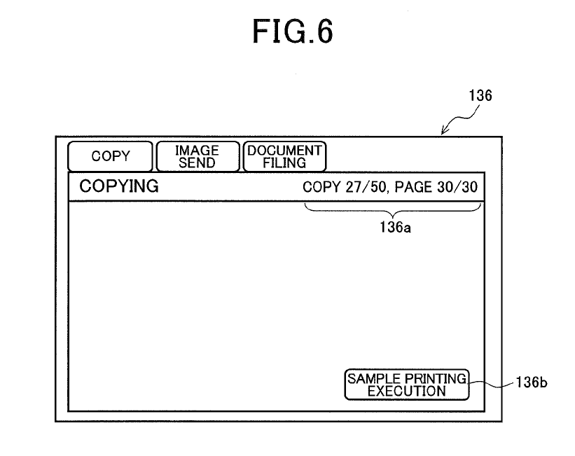

Further, in a case where the manual execution mode is selected on the sample printing setting screen 135 of FIG. 5B, upon pressing of the start key 121d of FIG. 3, the image forming apparatus 1 starts a print job and displays a print job in execution screen 136 as shown in FIG. 6. This print job in execution screen 136 has a job progress information 136a showing a progress situation of a print job and a sample printing execution key 136b for indicating execution of sample printing. The job progress information 136a is information showing what page of what copy is currently being printed, and, for example, in the case of a print job that 50 copies of a document with 30 pages/copy are printed, it is shown that the 30th page of the 27th copy is being printed. While seeing this job progress information 136a, the user presses the sample printing execution key 136b at a timing of desired copy and page. The image forming apparatus 1 executes sample printing accordingly.

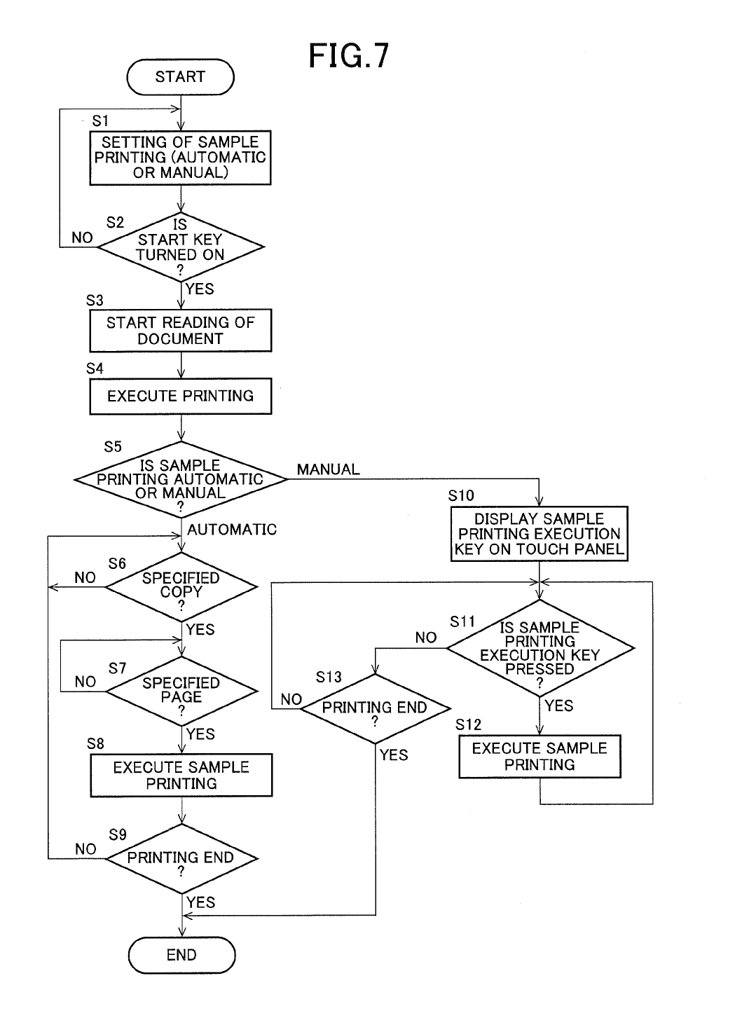

FIG. 7 is a flowchart explaining an example of sample printing processing by the image forming apparatus 1 of the present invention. First, in the image forming apparatus 1, a document with 30 pages is set at a predetermined position, 50 copies is specified as the number of copies to be printed from the standard screen 130 of FIG. 5A by an operation of a user, and the automatic execution mode or the manual execution mode is set from the sample printing setting screen 135 of FIG. 5B (step S1).

The image forming apparatus 1 judges whether or not the start key 121d (FIG. 3) is pressed by the user (step S2), and in the case of judging that the start key 121d is not pressed (in the case of NO), the procedure returns to step S1 to repeat processing. Moreover, in the case of judging that the start key 121d is pressed at step S2 (in the case of YES), reading of the document is started (step S3) to execute printing (step S4).

Next, the image forming apparatus 1 judges whether the execution mode of sample printing set at step S1 is the automatic execution mode or the manual execution mode (step S5), and in the case of judging that the execution mode of sample printing is the automatic execution mode (in the case of automatic in the figure), judges whether or not a print job in execution is for a specified copy (step S6). In the case of judging that the print job in execution is for the specified copy at step S6 (in the case of YES), the image forming apparatus 1 then judges whether or not the print job in execution is for a specified page (step S7). Further, in the case of judging that the print job in execution is not for the specified copy (in the case of NO), the procedure moves to a standby state at step S6.

Next, in the case of judging that the print job in execution is for the specified page at step S7 (in the case of YES), the image forming apparatus 1 executes sample printing for the page as well as prints the printing condition of sample printing (step S8). Moreover, in the case of judging that the print job in execution is not for the specified page at step S7 (in the case of NO), the procedure moves to a standby state at step S7.

Next, the image forming apparatus 1 judges whether or not printing ends (step S9), and in the case of judging that printing ends (in the case of YES), the procedure ends as it is, and in the case of judging that printing does not end (in the case of NO), the procedure returns to step S6 to repeat processing.

Moreover, in the case of judging that the execution mode of sample printing is the manual execution mode at step S5 (in the case of manual in the figure), the image forming apparatus 1 displays the sample printing execution key 136b on the touch panel as shown in FIG. 6 (step S10). Then, the image forming apparatus 1 judges whether or not the sample printing execution key 136b is pressed by the user (step S11), and in the case of judging that the sample printing execution key 136b is pressed (in the case of YES), executes sample printing for a corresponding page of the print job in execution as well as prints the printing condition of sample printing (step S12), and the procedure returns to step S11 to move to a standby state. Further, in the case of judging that the sample printing execution key 136b is not pressed at step S11 (in the case of NO), whether or not printing ends is judged (step S13), and in the case of judging that printing ends (in the case of YES), the procedure ends as it is, and in the case of judging that printing does not end (in the case of NO), the procedure returns to step S11 to repeat processing.

Though description has been given above by exemplifying a copy job as a print job, the present invention is applicable in the same manner also to a print job transmitted from an external terminal apparatus such as a PC (personal computer) when sample printing is performed in the automatic execution mode. In this case, by a printer driver installed in the terminal apparatus, the sample printing setting screen as shown in FIG. 5B may be displayed to perform setting of the automatic execution mode.

As described above, the image forming apparatus according to the present invention is an image forming apparatus provided with a sample printing execution portion for, during execution of a print job, generating two printed matters with a same printing condition for at least a part of pages of the print job to discharge one of the printed matters to a first paper discharge tray as a printed matter of the print job and discharge the other printed matter to a second paper discharge tray different from the first paper discharge tray as a sample printed matter, in which the sample printing execution portion, in the case of performing sample printing of the sample printed matter, prints the printing condition of the print job corresponding to the sample printing, and discharges a sheet having the printing condition printed thereon to the second paper discharge tray. According to this, it is possible to perform confirming of a printed state (image quality) of the printed matter and confirming of the printing condition (for example, printed date and time, what copy number it is, a paper feed tray and the like) at the same time, and in a case where waste (loss) paper due to printing is generated, it is possible to easily specify date and time when the waste paper is generated, on what copy number the waste paper is generated, cause of generating the waste paper and the like.

Moreover, it is preferable that the sheet having the printing condition printed thereon is a sheet before or after the sample printed matter. According to this, in the same manner as above, it is possible to perform confirming of a printed state (image quality) of the printed matter and confirming of the printing condition (for example, printed date and time, what copy number it is, a paper feed tray and the like) at the same time, and in a case where waste (loss) paper due to printing is generated, it is possible to easily specify date and time when the waste paper is generated, on what copy number the waste paper is generated, cause of generating the waste paper and the like.

Moreover, it is preferable that the sheet having the printing condition printed thereon is a sheet of the sample printed matter, and the printing condition is printed in a margin part of the sample printed matter. According to this, it is not necessary to prepare a sheet for printing the printing condition separately, thus making it possible to save sheets.

Moreover, it is preferable that the printing condition includes printed date and time when the sample printed matter is subjected to sample printing, a copy number showing, when the print job is a print job of a plurality of copies, to what copy number the sample printed matter corresponds, and an execution condition showing whether sample printing of the sample printed matter is executed automatically or executed manually. According to this, in a case where waste paper due to printing is generated, it is possible to easily specify date and time when the waste paper is generated and on what copy number the waste paper is generated.

Moreover, it is preferable that a laser scanning portion which emits laser light corresponding to image data of the print job to a photoreceptor drum, and a high voltage generating portion which applies predetermined high voltage to a charging device, a developing device and a transfer device arranged around the photoreceptor drum are included, in which the printing condition includes a paper feed tray when the sample printed matter is subjected to sample printing, a laser power setting value of the laser scanning unit when the sample printed matter is subjected to sample printing, and high-voltage output setting value of the high voltage generating portion when the sample printed matter is subjected to sample printing. According to this, in a case where waste paper due to printing is generated, it is possible to easily specify cause of generating waste paper.

Moreover, it is preferable that a measuring portion which measures temperature and humidity in the image forming apparatus is included, in which the printing condition further includes temperature and humidity in the image forming apparatus by the measuring portion when the sample printed matter is subjected to sample printing. According to this, in a case where waste paper due to printing is generated, in the same manner as above, it is possible to easily specify cause of generating waste paper.

Hereinabove, according to the present invention, when sample printing is performed during execution of a print job, a sample printed matter and a printing condition thereof are printed, and they are discharged to the same paper discharge tray, so that it is possible to perform confirming of a printed state (image quality) of the printed matter and confirming of the printing condition (for example, printed date and time, what copy number it is, a paper feed tray and the like) at the same time, and in a case where waste (loss) paper due to printing is generated, it is possible to easily specify date and time when the waste paper is generated, on what copy number the waste paper is generated, cause of generating the waste paper and the like.

1. An image forming apparatus provided with a sample printing execution portion which, during execution of a print job, generates two printed matters for at least a part of pages of the print job on a same printing condition, discharges one of the printed matters to a first paper discharge tray as a printed matter of the print job and discharges the other printed matter to a second paper discharge tray different from the first paper discharge tray as a sample printed matter, wherein
the sample printing execution portion, when performing sample printing of the sample printed matter, prints the printing condition of the print job corresponding to the sample printing, and discharges a sheet having the printing condition printed thereon to the second paper discharge tray.

2. The image forming apparatus as defined in claim 1, wherein the sheet having the printing condition printed thereon is a sheet before or after the sample printed matter.

3. The image forming apparatus as defined in claim 1, wherein the sheet having the printing condition printed thereon is a sheet of the sample printed matter, and the printing condition is printed in a margin part of the sample printed matter.

4. The image forming apparatus as defined in claim 1, wherein the printing condition includes an execution condition showing whether sample printing of the sample printed matter is executed automatically or executed manually.

5. The image forming apparatus as defined in claim 1, wherein the printing condition includes printed date and time when the sample printed matter is subjected to sample printing, a copy number showing, when the print job is a print job of a plurality of copies, to what copy number the sample printed matter corresponds.

6. The image forming apparatus as defined in claim 4, wherein a laser scanning portion for emitting laser light corresponding to image data of the print job to a photoreceptor drum, a high voltage generating portion for applying predetermined high voltage to a charging device, a developing device, and a transfer device arranged around the photoreceptor drum are included, and
the printing condition includes a paper feed tray when the sample printed matter is subjected to sample printing, a laser power setting value of the laser scanning unit when the sample printed matter is subjected to sample printing, and a high-voltage output setting value of the high voltage generating portion when the sample printed matter is subjected to sample printing.

7. The image forming apparatus as defined in claim 4, wherein
a measuring portion for measuring temperature and humidity in the image forming apparatus is included, and
the printing condition further includes temperature and humidity in the image forming apparatus by the measuring portion when the sample printed matter is subjected to sample printing.
